(19) United States
(12) Patent Application Publication
(10) Pub. No.: US 2026/0159736 A1
(43) Pub. Date: Jun. 11, 2026

(54) CMP SLURRY COMPOSITION FOR POLISHING COPPER LAYER AND METHOD OF POLISHING COPPER LAYER USING THE SAME

(71) Applicant: SAMSUNG SDI CO., LTD., Yongin-si (KR)

(72) Inventors: Hye Youn JANG, Suwon-si (KR); Soo Yeon SIM, Suwon-si (KR); Dong Hun KANG, Suwon-si (KR); Won Jong JEONG, Suwon-si (KR); Se I MOON, Suwon-si (KR); Kun Bae NOH, Suwon-si (KR)

(73) Assignee: SAMSUNG SDI CO., LTD., Yongin-si (KR)

(21) Appl. No.: 19/405,891

(22) Filed: Dec. 2, 2025

(30) Foreign Application Priority Data
Dec. 6, 2024 (KR) 10-2024-0180067

(51) Int. Cl. C09K 3/14; C23F 3/04

(52) U.S. Cl. CPC C09K 3/1463; C23F 3/04

(57) ABSTRACT

Disclosed herein are a CMP slurry composition for polishing a copper layer, and a method of polishing a copper layer using the CMP slurry. The CMP slurry composition includes at least one solvent among a polar solvent and a nonpolar solvent, an abrasive agent, and a dishing and erosion inhibitor. The dishing and erosion inhibitor includes a mixture of a copolymer of acrylic acid and acrylamide, and a phosphorus compound.

### CROSS-REFERENCE TO RELATED APPLICATION

The present application claims priority to Korean Patent Application No. 10-2024-0180067, filed on Dec. 6, 2024 in the Korean Intellectual Property Office, the entire disclosure of which is incorporated herein by reference.

### FIELD OF THE DISCLOSURE

The present disclosure relates to a chemical mechanical polishing (CMP) slurry composition for polishing a copper layer, and a method of polishing a copper layer using the CMP slurry composition.

### DESCRIPTION OF THE RELATED ART

In light of recent trends towards higher integration and performance in semiconductor integrated circuits, CMP (chemical mechanical polishing) has emerged as a microfabrication technology frequently used in planarization of interlayer dielectric films, formation of metal plugs, and formation of embedded interconnects. In addition, copper and copper alloys are notable conductive materials recently employed in interconnect applications. Due to lower resistance thereof than aluminum and other metals, copper or copper alloys offer the advantage of significantly improving the performance of integrated circuits.

In general, CMP compositions for polishing a copper layer oxidize a copper layer using an oxidizing agent, mechanically polish the oxidized layer using an abrasive agent, and remove dissolved copper ions through complexation using a ligand or chelator. To regulate the extent of this process, a corrosion inhibitor may control corrosion. Colloidal silica is used as abrasive particles. High polishing rate is essential for improving semiconductor productivity. To achieve a high polishing rate using a CMP slurry composition, there has been proposed a method of increasing the content of the abrasive agent to increase the frequency of physical collisions, or a method of increasing the content of the chelator to increase a dissolution rate. However, the former method can increase the number of scratch defects, while in the latter method, the high chelator content can adversely affect flatness of a polished surface, and the amount of chelator used is limited by solubility thereof.

### SUMMARY OF THE DISCLOSURE

It is an example aspect of the present disclosure to provide a CMP slurry composition for polishing a copper layer that can polish a copper layer at a high polishing rate, can reduce dishing and erosion of the polished copper layer, and can ensure a low etch rate of the copper layer and thus enhanced flatness of a polished surface of the copper layer.

In accordance with one example aspect of the present disclosure, a CMP slurry composition for polishing a copper layer includes at least one solvent such as or including at least one of a polar solvent and a nonpolar solvent, an abrasive agent, and a dishing and erosion inhibitor. The dishing and erosion inhibitor includes a mixture of a copolymer of acrylic acid and acrylamide, and a phosphorus compound represented by Formula 1:

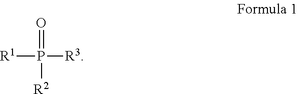

In Formula 1, R¹, R², and R³ each independently is or includes a hydroxyl group, a substituted or unsubstituted linear or branched C₁ to C₂₀ alkoxy group, a substituted or unsubstituted C₆ to C₂₀ aryloxy group, a compound represented by Formula 1-1, or a compound represented by Formula 1-2.

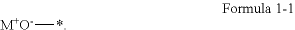

In Formula 1-1, * is a linking site to an element, and M is or includes an alkali metal or NH₄.

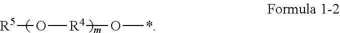

In Formula 1-2, * is a linking site to an element,
m is an integer in a range of 1 or greater,
R⁴ is or includes a substituted or unsubstituted linear or branched C₁ to C₂₀ alkylene group, and
R⁵ is or includes a substituted or unsubstituted C₆ to C₂₀ aryl group or a substituted or unsubstituted C₇ to C₂₀ arylalkyl group.

In accordance with another aspect of the present disclosure, a method of polishing a copper layer includes polishing a copper layer using the CMP slurry composition according to the present disclosure.

Example embodiments of the present disclosure include a CMP slurry composition for polishing a copper layer, which can polish a copper layer at a high polishing rate, can reduce dishing and erosion of the polished copper layer, and can ensure a low etch rate of the copper layer and thus enhanced flatness of a polished surface of the copper layer.

### DETAILED DESCRIPTION

Hereinafter, example embodiments of the present disclosure are described in detail such that the present disclosure can be readily implemented by a person having ordinary knowledge in the art. It should be understood that the present disclosure may be embodied in different ways and is not limited to the following example embodiments.

The terminology used herein is for the purpose of describing example embodiments and is not intended to limit the present disclosure. As used herein, the singular forms “a”, “an” and “the” are intended to include the plural forms as well, unless the context clearly indicates otherwise.

As used herein, “substituted” in “substituted or unsubstituted” means that at least one hydrogen atom in a corresponding functional group is substituted with one of a hydroxyl group, a C₁ to C₁₀ alkyl group or haloalkyl group, a C₂ to C₁₀ alkenyl group or haloalkenyl group, a C₂ to C₁₀ alkynyl group or haloalkynyl group, a C₃ to C₁₀ cycloalkyl group, a C₃ to C₁₀ cycloalkenyl group, a C₆ to C₁₀ aryl group, a C₇ to C₁₀ arylalkyl group, a C₁ to C₁₀ alkoxy group, a C₆ to C₁₀ aryloxy group, an amino group, a halogen group, a cyano group, or a thiol group.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

In accordance with one aspect of the present disclosure, a CMP slurry composition for polishing a copper layer includes at least one of a polar solvent and a nonpolar solvent, an abrasive agent, and a dishing and erosion inhibitor. The dishing and erosion inhibitor includes a mixture of a copolymer of acrylic acid and acrylamide, and a phosphorus compound represented by Formula 1.

The mixture of the copolymer of acrylic acid and acrylamide, and the phosphorus compound represented by Formula 1 can significantly enhance a polishing rate with respect to a copper layer, and can significantly reduce dishing and erosion of the polished copper layer and an etch rate of the copper layer. Thus, the mixture can enhance a polishing rate with respect to a copper layer while improving flatness of a polished surface of the copper layer.

Below, each component of the CMP slurry composition according to one example embodiment is described in detail.

### Solvent

The at least one of a polar solvent and a nonpolar solvent may reduce friction upon polishing a copper layer with the abrasive agent. The at least one solvent may include at least one of water (for example, ultrapure water or deionized water), organic amines, organic alcohols, organic alcohol amines, organic ethers, organic ketones, and the like. For example, ultrapure water or deionized water is used as the solvent.

The at least one solvent may be present in the balance amount, for example, in an amount in a range of about 30 wt % to about 99 wt %, in the CMP slurry composition.

### Abrasive Agent

The abrasive agent may include a typical abrasive agent used for polishing. For example, the abrasive agent may include metal or non-metal oxide abrasive particles. The abrasive agent may include, for example, at least one of silica including colloidal silica, fumed silica, and the like, alumina, ceria, titania, and zirconia. In one example embodiment, the abrasive agent may include silica (for example, colloidal silica), without being limited thereto.

The abrasive agent comprises spherical or non-spherical particles, and may have an average primary particle diameter (D₅₀) in a range of about 10 nm to about 150 nm, for example, 20 nm to 70 nm. Within the above range, a high polishing rate with respect to a copper layer can be achieved, scratches can be reduced or prevented, and flatness of a polished surface can be improved. Herein, “average particle diameter (D₅₀)” is a typical particle diameter measure known in the art and refers to a particle diameter of the abrasive particles corresponding to 50 vol % when the abrasive particles are distributed in order from smallest to largest in terms of volume.

The abrasive agent may be subjected to surface modification, or may not be subjected to surface modification. Surface-modified abrasive particles can have further improved dispersion stability in the CMP slurry composition, or can achieve a further enhanced polishing rate.

Surface modification of the abrasive agent may be performed by treating the abrasive agent with a surface modifying compound. In one example embodiment, the surface modifying compound may include a silane compound. When the abrasive agent is silica, the silane compound can facilitate surface modification of the abrasive agent. The silane compound may include at least one of mercapto group-containing alkoxysilanes, amino group-containing alkoxysilanes, tetraalkoxysilanes, and alkyl group-containing alkoxysilanes having a C₁ to C₁₀ alkyl group, without being limited thereto. In another example embodiment, silica as the abrasive agent may be subjected to primary surface modification with a compound having a sulfonate group or a phosphate group, and then may be subjected to a secondary surface modification with an alkoxysilane (for example, tetraethoxysilane).

The abrasive agent may be present in an amount in a range of about 0.001 wt % to about 20 wt %, 0.005 wt % to 10 wt %, 0.01 wt % to 5 wt %, or 0.05 wt % to 3 wt %, in the CMP slurry composition. Within this range, a sufficient polishing rate with respect to a copper layer can be achieved, scratches can be reduced or prevented, and dispersion stability of the abrasive agent in the composition can be improved.

### Dishing and Erosion Inhibitor

When a copper layer is polished using a CMP slurry composition, dishing and erosion can occur on the resulting polished surface. Dishing is a phenomenon in which metal trenches become recessed over a wide area due to excessive removal of copper during polishing of a copper layer. Erosion is a phenomenon in which metal trenches become recessed as surrounding materials are removed together with copper during polishing of a copper layer.

The dishing and erosion inhibitor includes a mixture of a copolymer of acrylic acid and acrylamide, and a phosphorus compound represented by Formula 1 discussed above. A CMP slurry composition including only the copolymer of acrylic acid and acrylamide as the dishing and erosion inhibitor can cause a high degree of dishing and erosion, resulting in degradation of overall wafer performance. In addition, a CMP slurry composition including only the phosphorus compound represented by Formula 1 as the dishing and erosion inhibitor can exhibit a reduction in the polishing rate depending on the content of the phosphorus compound.

The copolymer of acrylic acid and acrylamide may be or include a copolymer of a monomer mixture comprising acrylic acid and acrylamide, as represented by Formula 2:

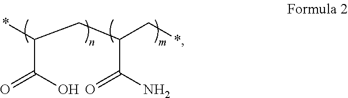

where * is a linking site to an element, and
each of n and m is the number of moles of a corresponding repeat unit.

In one example embodiment, acrylic acid and acrylamide may be present in a mole ratio in a range of about 1:30 to about 30:1 (acrylic acid:acrylamide) in the monomer mixture. Within the above range, the dishing and erosion inhibitor can inhibit dishing and erosion without reduction in polishing rate with respect to a copper layer. For example, the mole ratio of acrylic acid to acrylamide may be in a range of about 5:95 to about 95:5, for example, 10:90 to 80:20, 50:50 to 80:20, or 70:30, based on the total mole number of acrylic acid and acrylamide.

In one example embodiment, the copolymer of acrylic acid and acrylamide may have a weight average molecular weight (Mw) in a range of about 600,000 g/mol to about 2,000,000 g/mol, for example, 1,000,000 g/mol to 2,000,000 g/mol, or 1,000,000 g/mol to 1,500,000 g/mol. Within the above range, the dishing and erosion inhibitor can inhibit dishing and erosion without reduction in polishing rate with respect to a copper layer.

Herein, “weight average molecular weight” may be determined by gel permeation chromatography using pullulan as a molecular weight standard reagent and an aqueous mobile phase.

The copolymer of acrylic acid and acrylamide may be present in an amount in a range of about 0.0001 wt % to about 1 wt %, for example, 0.0001 wt % to 0.5 wt %, 0.0005 wt % to 0.1 wt %, or 0.0005 wt % to 0.01 wt %, in the CMP slurry composition. Within the above range, the dishing and erosion inhibitor can inhibit dishing and erosion without reduction in polishing rate with respect to a copper layer.

The phosphorus compound is represented by Formula 1. The CMP slurry composition may include one or more phosphorus compounds represented by Formula 1:

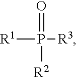

where R¹, R², and R³ each independently is or includes a hydroxyl group, a substituted or unsubstituted linear or branched C₁ to C₂₀ alkoxy group, a substituted or unsubstituted C₆ to C₂₀ aryloxy group, a compound represented by Formula 1-1, or a compound represented by Formula 1-2.

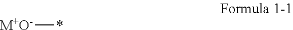

where * is a linking site to an element, and M is or includes an alkali metal or NH₄.

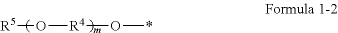

where * is a linking site to an element,
m is an integer in a range of 1 or greater,
R⁴ is or includes a substituted or unsubstituted linear or branched C₁ to C₂₀ alkylene group, and
R⁵ is or includes substituted or unsubstituted C₆ to C₂₀ aryl group or a substituted or unsubstituted C₇ to C₂₀ arylalkyl group.

In Formula 1, the alkali metal may be lithium, sodium, potassium, rubidium, cesium, or francium.

In one example embodiment, in Formula 1, R¹, R², and R³ may each independently be or include a hydroxyl group, a substituted or unsubstituted linear or branched C₄ to C₁₅ alkoxy group, a substituted or unsubstituted C₆ to C₂₀ aryloxy group, the compound represented by Formula 1-1, or the compound represented by Formula 1-2.

In one example embodiment, the phosphorus compound may include at least one of the compounds represented by Formulas 1-3 to 1-7, respectively.

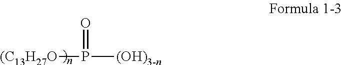

where n is an integer in a range of 0 to 3.

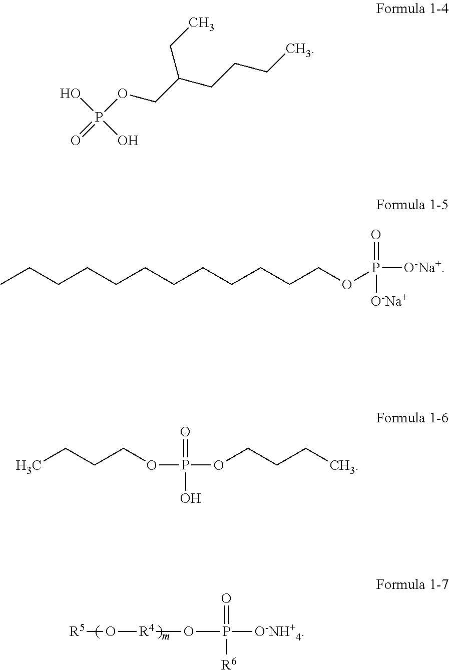

where each of R⁴, R⁵, and m is as defined in Formula 1-2, and
R⁶ is or includes a hydroxyl group, a substituted or unsubstituted linear or branched C₁ to C₂₀ alkoxy group, a substituted or unsubstituted C₆ to C₂₀ aryloxy group, or the compound represented by Formula 1-1.

The phosphorus compound represented by Formula 1 may be present in an amount in a range of about 0.0001 wt % to about 1 wt %, for example, 0.0001 wt % to 0.5 wt %, 0.0005 wt % to 0.1 wt %, or 0.001 wt % to 0.01 wt %, in the CMP slurry composition. Within the above range, the dishing and erosion inhibitor can inhibit dishing and erosion without reduction in polishing rate with respect to a copper layer.

The copolymer and the phosphorus compound represented by Formula 1 are required to be present in an appropriate ratio. In one example embodiment, the copolymer and the phosphorus compound represented by Formula 1 may be present in a weight ratio in a range of about 1:1 to about 1:10, for example, 1:2 to 1:7, or 1:3 to 1:6. Within the above range, the dishing and erosion inhibitor can reduce defects without reduction in polishing rate with respect to a copper layer.

The dishing and erosion inhibitor may be present in an amount in a range of about 0.0001 wt % to about 1 wt %, for example, 0.0001 wt % to 0.5 wt %, 0.0005 wt % to 0.1 wt %, 0.001 wt % to 0.01 wt %, in the CMP slurry composition. Within the above range, the dishing and erosion inhibitor can reduce defects without reduction in polishing rate with respect to a copper layer.

The CMP slurry composition may further include at least one of an oxidizing agent, a complexing agent, a corrosion inhibitor, and a pH adjuster.

The oxidizing agent can facilitate polishing of a copper layer by oxidizing the copper layer, and can ensure good surface roughness after polishing by leveling the surface of the copper layer.

The oxidizing agent may include at least one of an inorganic per-compound, an organic per-compound, bromic acid or salts thereof, nitric acid or salts thereof, chloric acid or salts thereof, chromic acid or salts thereof, iodic acid or salts thereof, iron or salts thereof, copper or salts thereof, a rare-earth metal oxide, a transition metal oxide, and potassium dichromate. Herein, “per-compound” refers to a compound containing at least one peroxide group (—O—O—) or containing an element in the highest oxidation state. For example, the oxidizing agent includes a per-compound. For example, the per-compound may include at least one of hydrogen peroxide, potassium periodate, calcium persulfate, and potassium ferricyanide, for example hydrogen peroxide.

The oxidizing agent may be present in an amount in a range of about 0.01 wt % to about 5 wt %, for example 0.05 wt % to 4 wt %, or 0.1 wt % to 3 wt %, in the CMP slurry composition. Within the above range, the oxidizing agent can improve polishing selectivity to a copper layer.

The complexing agent may further enhance a polishing rate with respect to a copper layer.

The complexing agent may include a typical complexing agent known to those skilled in the art. For example, the complexing agent may include at least one of amino acids (for example, glycine), imidazole, ammonia, amino alcohols, polyamines, polyhydric alcohols (for example, dihydric alcohols, trihydric alcohols, ethylene glycol, pyrocatechol, pyrogallol, and the like), carbonyl compounds (for example, acetylacetonate, and the like), simple carboxylic acids and salts thereof (for example, acetic acid and salts thereof, arylcarboxylic acid and salts thereof, and the like), carboxylic acids containing one or more hydroxyl groups and salts thereof (for example, glycolic acid and salts thereof, lactic acid and salts thereof, gluconic acid and salts thereof, gallic acid and salts thereof, and the like), di-, tri-, or polycarboxylic acids and salts thereof (for example, oxalic acid and salts thereof, phthalic acid and salts thereof, citric acid and salts thereof, succinic acid and salts thereof, tartaric acid and salts thereof, malic acid and salts thereof, EDTA and salts thereof (for example, dipotassium EDTA), mixtures thereof, and the like), carboxylic acids containing one or more sulfonic acid groups and/or phosphonic acid groups and salts thereof, di-, tri- or polyhydric alcohols (for example, ethylene glycol, pyrocatechol, pyrogallol, tannic acid, and the like), and amine-containing compounds (for example, ammonia, amino acids, amino alcohols, di-, tri-, and polyamines, and the like), without being limited thereto.

The complexing agent may be present in an amount in a range of about 0.01 wt % to about 5 wt %, 0.05 wt % to 5 wt %, or 0.1 wt % to 5 wt %, in the CMP slurry composition. Within the above range, the complexing agent can enhance a polishing rate with respect to a copper layer and dispersion stability of abrasive particles in slurry and can improve surface characteristics of a polished copper layer.

The corrosion inhibitor is a substance that is configured to delay a chemical reaction of the oxidizing agent, and may constitute a polishing regulator that enables polishing in high stepped regions in which physical abrasion occurs by allowing removal of copper by physical action of the abrasive particles and reduces or suppresses corrosion in low stepped regions in which physical abrasion does not occur.

As the corrosion inhibitor, a nitrogen-containing compound may be used. For example, the corrosion inhibitor may include at least one of ammonia, alkylamine compounds, amino acid compounds, imine compounds, and azole compounds.

In one example embodiment, the corrosion inhibitor may include an azole compound, for example, at least one of a triazole compound and a tetrazole compound.

The triazole compound may include at least one of benzotriazole compounds including benzotriazole, methyl benzotriazole (tolyltriazole) including 5-methylbenzotriazole (for example, 5-methyl-1H-benzotriazole), 4-methylbenzotriazole, and the like, ethyl benzotriazole, propyl benzotriazole, butyl benzotriazole, pentyl benzotriazole, hexyl benzotriazole, hydroxybenzotriazole, and the like; 1,2,4-triazole; 1,2,3-triazole, and the like. The triazole compound may be present as the triazole compound itself or in the form of salts thereof in the CMP slurry composition.

The tetrazole compound may include at least one of 5-aminotetrazole, 5-methyltetrazole, and 5-phenyltetrazole. The tetrazole compound may be present as the tetrazole compound itself, or may be in the form of salts thereof in the CMP slurry composition.

The corrosion inhibitor may be present in an amount in a range of about 0.001 wt % to about 5 wt %, 0.005 wt % to 1 wt %, or 0.01 wt % to 0.1 wt %, in the CMP slurry composition. Within the above range, the corrosion inhibitor can reduce or suppress dishing of a copper layer during polishing while enhancing a polishing rate with respect to the copper layer.

The CMP slurry composition may have a pH in a range of about 5 to about 9, for example 6 to 8. Within the above range, corrosion of a copper layer can be reduced or prevented.

The CMP slurry composition may further include a pH adjuster to adjust the pH of the composition to the above range. In one example embodiment, the pH adjuster may include an inorganic acid, for example, at least one of nitric acid, phosphoric acid, hydrochloric acid, and sulfuric acid, and an organic acid, for example, an organic acid having a pKₐ in a range of about 6 or less, for example, at least one of acetic acid and phthalic acid. In another example embodiment, the pH adjuster may include a base, for example, at least one of sodium hydroxide, potassium hydroxide, ammonium hydroxide, sodium carbonate, and potassium carbonate.

The CMP slurry composition may further include at least one of a pesticide and a germicide to inhibit microbial growth and/or contamination. Each of, or at least one of, the pesticide and the germicide may include a material commonly used in CMP slurry compositions to achieve the aforementioned purpose.

The CMP slurry composition may further include typical additives, such as, e.g., surfactants, dispersants, modifiers, surface active agents, and the like.

In accordance with another aspect of the present disclosure, a method of polishing a copper layer includes polishing a copper layer using the CMP slurry composition according to the present disclosure.

The present disclosure is described in more detail below with reference to some examples. It should be understood that these examples are provided for illustration only, and are not to be construed in any way as limiting the present disclosure.

Details of components used in Examples and Comparative Examples are as follows.
Abrasive agent: Colloidal silica (NP60, average particle diameter: 50 nm)
Complexing agent: Glycine
Corrosion inhibitor 1: 1,2,4-triazole
Corrosion inhibitor 2: 5-methyl-1H-benzotriazole
Dishing and erosion inhibitor 1: A copolymer obtained by copolymerization of acrylic acid and acrylamide in a mole ratio of 7:3 and having a weight average molecular weight of 1,300,000 g/mol
Dishing and erosion inhibitor 2:
Dishing and erosion inhibitor 2-1: A compound represented by Formula 1-3 (where n is 1).
Dishing and erosion inhibitor 2-2: A compound represented by Formula 1-4.
Dishing and erosion inhibitor 2-3: A compound represented by Formula 1-5.
Dishing and erosion inhibitor 2-4: A compound represented by Formula 1-6.
Dishing and erosion inhibitor 2-5: A compound represented by Formula 1-7. R⁴ is an ethylene group, R⁵ is a benzyl group, R⁶ is —O⁻NH₄⁺, and m is an integer of 1 or greater.
Oxidizing agent: Hydrogen peroxide.
pH adjuster: Nitric acid or potassium hydroxide.

### Example 1

A CMP slurry composition was prepared by mixing 0.2 wt % of an abrasive agent, 1.5 wt % of a complexing agent, 0.0033 wt % of corrosion inhibitor 1, 0.0021 wt % of corrosion inhibitor 2, 0.001 wt % of dishing and erosion inhibitor 1, and 0.005 wt % of dishing and erosion inhibitor 2-1, based on the total weight of the CMP slurry composition, followed by adding ultrapure water. The CMP slurry composition was adjusted to a pH of 7.3 using a pH adjuster. Thereafter, 1.00 wt % of hydrogen peroxide (liquid, Dongwoo Fine-Chem Co. Ltd.) as an oxidizing agent was added, thereby preparing a CMP slurry composition for property evaluation shown in Table 1 below. In Table 1, “-” means that a corresponding component was not used.

### Example 2

A CMP slurry composition for property evaluation was prepared in the same manner as in Example 1, with a difference that 0.005 wt % of dishing and erosion inhibitor 2-2 was used instead of dishing and erosion inhibitor 2-1.

### Example 3

A CMP slurry composition for property evaluation was prepared in the same manner as in Example 1, with a difference that 0.005 wt % of dishing and erosion inhibitor 2-3 was used instead of dishing and erosion inhibitor 2-1.

### Example 4

A CMP slurry composition for property evaluation was prepared in the same manner as in Example 1, with a difference that 0.005 wt % of dishing and erosion inhibitor 2-4 was used instead of dishing and erosion inhibitor 2-1.

### Example 5

A CMP slurry composition for property evaluation was prepared in the same manner as in Example 1, with a difference that 0.005 wt % of dishing and erosion inhibitor 2-5 was used instead of dishing and erosion inhibitor 2-1.

### Comparative Example 1

A CMP slurry evaluation composition for property evaluation was prepared in the same manner as in Example 1, with a difference that both dishing and erosion inhibitor 1 and dishing and erosion inhibitor 2-1 were not used.

### Comparative Example 2

A CMP slurry evaluation composition for property evaluation was prepared in the same manner as in Example 1, with a difference that dishing and erosion inhibitor 2-1 was not used.

Each of the CMP slurry compositions prepared in Examples and Comparative Examples was evaluated as to the following properties:

(1) Copper layer polishing rate (unit: Å/min): A copper layer was polished on a 300 mm polisher (AMAT Co., Ltd.) using an IC1010 polishing pad (Rodel Inc.) under the same conditions: a platen speed of 93 rpm, a head speed of 87 rpm, a down pressure of 1.5 psi, a slurry flow rate of 150 ml/min, and a polishing time of 60 seconds. The polishing rate with respect to the copper layer was calculated by converting the difference in film thickness before and after polishing from electrical resistance measurements.

(2) Dishing and erosion of copper layer (unit: Å): The degree of dishing and erosion of a copper layer was determined based on Atomic Force Microscopy (AFM) measurements after polishing for the same over-polishing time.

(3) Copper layer etch rate (unit: Å/min): A polishing solution was held in a high-temperature (60° C.) bath for 30 minutes to be heated to an elevated temperature, followed by the addition of hydrogen peroxide, and then a coupon wafer was immersed in the bath for 15 seconds, followed by calculation of an etch rate in the thickness direction of the wafer based on resistance measurements.

TABLE 1

| | | | | | | | Comparative | |
|---|---|---|---|---|---|---|---|---|
| | | Example | | | | | Example | |
| | | 1 | 2 | 3 | 4 | 5 | 1 | 2 |
| Abrasive | | 0.2 | 0.2 | 0.2 | 0.2 | 0.2 | 0.2 | 0.2 |
| agent | | | | | | | | |
| Complexing | | 1.5 | 1.5 | 1.5 | 1.5 | 1.5 | 1.5 | 1.5 |
| agent | | | | | | | | |
| Corrosion | | 0.0033 | 0.0033 | 0.0033 | 0.0033 | 0.0033 | 0.0033 | 0.0033 |
| inhibitor 1 | | | | | | | | |
| Corrosion | | 0.0021 | 0.0021 | 0.0021 | 0.0021 | 0.0021 | 0.0021 | 0.0021 |
| inhibitor 2 | | | | | | | | |
| Dishing and | | 0.001 | 0.001 | 0.001 | 0.001 | 0.001 | — | 0.001 |
| erosion | | | | | | | | |
| inhibitor 1 | | | | | | | | |
| Dishing | 2-1 | 0.005 | — | — | — | — | — | — |
| and | 2-2 | — | 0.005 | — | — | — | — | — |
| erosion | 2-3 | — | — | 0.005 | — | — | — | — |
| inhibitor | 2-4 | — | — | — | 0.005 | — | — | — |
| 2 | 2-5 | — | — | — | — | 0.005 | — | — |

TABLE 2

| | Copper | Copper | Copper | Copper |
|---|---|---|---|---|
| | polishing rate | Dishing | Erosion | etch rate |
| Example 1 | 11,672 | 121 | 26 | 154 |
| Example 2 | 12,583 | 133 | 21 | 362 |
| Example 3 | 12,959 | 121 | 21 | 149 |
| Example 4 | 13,053 | 120 | 17 | 126 |
| Example 5 | 11,353 | 95 | 20 | 642 |
| Comparative | 9,450 | 201 | 40 | 821 |
| Example 1 | | | | |
| Comparative | 9,497 | 193 | 50 | 809 |
| Example 2 | | | | |

As shown in Table 2 above, the CMP slurry compositions prepared in Examples 1 to 5 exhibited a significantly high polishing rate with respect to a copper layer while ensuring a low etch rate of the copper layer, thereby enabling improvement in flatness of a polished surface of the copper layer.

Conversely, the CMP slurry compositions prepared in Comparative Examples 1 and 2 exhibited a low polishing rate with respect to a copper layer and caused high degrees of dishing, erosion, and etching of the copper layer, resulting in poor flatness of a polished surface of the copper layer.

It should be understood that various modifications, changes, alterations, and equivalent embodiments can be made by those skilled in the art without departing from the spirit and scope of the disclosure.

What is claimed is:

1. A CMP slurry composition for polishing a copper layer, the CMP slurry composition comprising:
at least one of a polar solvent and a nonpolar solvent;
an abrasive agent; and
a dishing and erosion inhibitor,
wherein the dishing and erosion inhibitor comprises a mixture of a copolymer of acrylic acid and acrylamide, and a phosphorus compound represented by Formula 1: 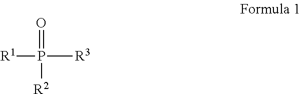
where R¹, R², and R³ each independently comprises a hydroxyl group, a substituted or unsubstituted linear or branched C₁ to C₂₀ alkoxy group, a substituted or unsubstituted C₆ to C₂₀ aryloxy group, a compound represented by Formula 1-1, or a compound represented by Formula 1-2; 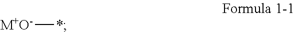
where * is a linking site to an element, and M comprises an alkali metal or NH₄, 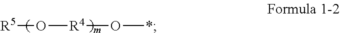
where * is a linking site to an element,
m is an integer in a range of 1 or greater,
R⁴ comprises a substituted or unsubstituted linear or branched C₁ to C₂₀ alkylene group, and
R⁵ comprises a substituted or unsubstituted C₆ to C₂₀ aryl group or a substituted or unsubstituted C₇ to C₂₀ arylalkyl group.

2. The CMP slurry composition as claimed in claim 1, wherein R¹, R², and R³ each independently comprises a hydroxyl group, a substituted or unsubstituted linear or branched C₄ to C₁₅ alkoxy group, a substituted or unsubstituted C₆ to C₂₀ aryloxy group, the compound represented by Formula 1-1, or the compound represented by Formula 1-2.

3. The CMP slurry composition as claimed in claim 1, wherein the phosphorus compound comprises at least one of compounds represented by Formulas 1-3 to 1-7, respectively: 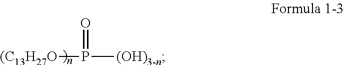
where n is an integer in a range of 0 to 3; 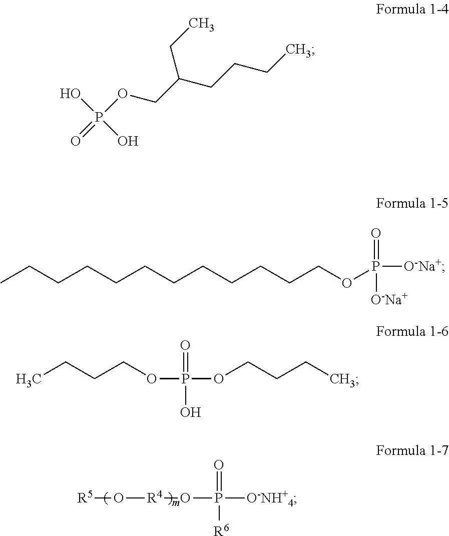
wherein each of R⁴, R⁵, and m is as defined in Formula 1-2, and
R⁶ comprises a hydroxyl group, a substituted or unsubstituted linear or branched C₁ to C₂₀ alkoxy group, a substituted or unsubstituted C₆ to C₂₀ aryloxy group, or the compound represented by Formula 1-1.

4. The CMP slurry composition as claimed in claim 1, wherein the acrylic acid and the acrylamide are present in a mole ratio in a range of about 1:30 to about 30:1 (acrylic acid:acrylamide) in a monomer mixture for the copolymer.

5. The CMP slurry composition as claimed in claim 1, wherein the copolymer of acrylic acid and acrylamide has a weight average molecular weight (Mw) in a range of about 600,000 g/mol to about 2,000,000 g/mol.

6. The CMP slurry composition as claimed in claim 1, wherein a weight ratio of the copolymer to the phosphorus compound represented by Formula 1 ranges from about 1:1 to about 1:10.

7. The CMP slurry composition as claimed in claim 1, wherein at least one of the copolymer of acrylic acid and acrylamide and the phosphorus compound represented by Formula 1 is present in an amount in a range of about 0.0001 wt % to about 1 wt % in the CMP slurry composition.

8. The CMP slurry composition as claimed in claim 1, further comprising:
at least one of an oxidizing agent, a complexing agent, a corrosion inhibitor, and a pH adjuster.

9. The CMP slurry composition as claimed in claim 8, comprising:
about 0.001 wt % to about 20 wt % of the abrasive agent;
about 0.0001 wt % to about 1 wt % of the dishing and erosion inhibitor;
about 0.01 wt % to about 5 wt % of the complexing agent;
about 0.001 wt % to about 5 wt % of the corrosion inhibitor; and
about 0.01 wt % to about 5 wt % of the oxidizing agent.

10. The CMP slurry composition as claimed in claim 1, wherein the CMP slurry composition has a pH in a range of about 5 to about 9.

11. A method of polishing a copper layer, the method comprising:
polishing a copper layer using the CMP slurry composition as claimed in claim 1.
